(19) United States
(12) Patent Application Publication
(10) Pub. No.: US 2026/0302398 A1
(43) Pub. Date: Oct. 1, 2026

(54) THERMAL REGULATION DEVICE, IN PARTICULAR A COOLING DEVICE, FOR A MOTOR VEHICLE

(71) Applicant: VALEO SYSTEMES THERMIQUES, Le Mesnil-Saint-Denis (FR)

(72) Inventors: Aurelie BELLENFANT, Le Mesnil-Saint-Denis (FR); Fethy DJALLAL, Le Mesnil-Saint-Denis (FR); Julien VERON, Le Mesnil-Saint-Denis (FR); Marc HERRY, Le Mesnil-Saint-Denis (FR)

(73) Assignee: VALEO SYSTEMES THERMIQUES, Le Mesnil-Saint-Denis (FR)

(21) Appl. No.: 19/474,914

(22) PCT Filed: Apr. 22, 2024
(86) PCT No.: PCT/EP2024/060868

§ 371 Date: Oct. 13, 2025

(30) Foreign Application Priority Data
Apr. 27, 2023 (FR) FR2304286

(51) Int. Cl. H01M 10/613; H01M 10/625; H01M 10/6557

(52) U.S. Cl. CPC H01M 10/613; H01M 10/625; H01M 10/6557; H01M 2220/20

(57) ABSTRACT

A thermal regulation device for cooling electrical energy storage members includes a tube that configured to contact the electrical energy storage members and has at least one circulation channel for heat transfer fluid. A collecting tank is disposed at one end of the tube and includes at least one collecting chamber in fluidic communication with the at least one circulation channel of the tube, which is connected to a first end of the tube. The collecting tank includes a first part and a second part secured to the first part and to the tube, wherein the second part of the collecting tank has an orifice defined by a flange turn-up (raised edge) configured to be passed through by the tube. A peripheral edge is intended to be in contact with the first part of the collecting tank, and allows it to be secured thereto, preferably by brazing.

The present invention relates to a thermal regulation device, in particular a cooling device, in particular for an electrical component that is liable to release heat during its operation, in particular a cooling device for at least one battery or battery cells of a vehicle, for example one vehicle. The vehicle may be a land vehicle, marine vehicle or air vehicle.

These days, it is known for electric, thermal or hybrid vehicles to be equipped with electrical energy storage members for supplying electric power to the different elements of the vehicle. These electrical energy storage members are generally made up of electrical energy storage cells arranged in a battery pack.

Automotive manufacturers are currently seeking to supply more powerful electric or hybrid vehicles with increased electric range. To this end, increasing numbers of battery packs, and/or increasingly large battery packs, are being installed in these electric or hybrid vehicles. It is known practice for all or at least some these battery packs to be installed in the floor of the vehicle, substantially across the entire width of the vehicle.

It will be understood that, when the vehicle is running, the battery packs can release a significant amount of heat and consequently be subjected to temperature increases that in some cases can damage or even destroy them. Therefore, it is essential to cool them in order to keep them in good condition and thus to ensure the reliability, range and performance level of the vehicle. Furthermore, the battery packs may operate less efficiently at low temperatures, with the electrical or electronic components equipping these battery packs then needing time to warm up before operating at full capacity.

For this purpose, one or more thermal regulation devices that are intended to regulate the temperature of the battery packs are employed so as to ensure the functions of heating and/or cooling the electrical or electronic components within these battery packs and thus to optimize the operation of the various components.

These thermal regulation devices are generally passed through by a heat transfer fluid which, depending on the requirements, can either absorb the heat emitted by each battery pack in order to cool it, or supply heat if the temperature of the battery pack is insufficient for it to operate properly.

In battery packs in which electrical energy storage cells are disposed vertically one beside the other so as to form a plurality of successive rows of cells, it is, in particular, known to have thermal regulation devices having a tube which is disposed between two rows of cells and within which the heat transfer fluid is able to circulate. The contact between the tube and the cells allows heat energy to be discharged, or supplied, via the heat transfer fluid.

To manage the intake and discharge of the heat transfer fluid, a fluid collecting tank is disposed at one end of the tube and heat transfer fluid intake and outlet ducts are connected to this collecting tank. More particularly, when a plurality of thermal regulation devices are disposed in parallel in order to be respectively inserted between two rows of cells, and when the ducts need to be connected successively to each collecting tank of the thermal regulation devices, it is known practice to respectively form the heat transfer fluid intake duct and the heat transfer fluid outlet duct by way of a succession of tubular portions including sleeves secured to each collecting tank and additional connection means interposed between the sleeves in order to fix them to one another and to allow heat transfer fluid to pass in a leaktight manner within each of the tubular portions.

The size of the battery packs needs to be increasingly large in order to meet the increasing electrical energy requirements of modern electric or hybrid vehicles, and the number of rows of cells, and therefore there has to be an increasing number of tubes interposed between these rows of cells in order to effect thermal regulation. As a result, the connection of the ducts to the various collecting tanks can be laborious owing to the large number of parts to be joined together,

Furthermore, the multiplication of the number of parts and of their respective manufacturing tolerances means larger assembly sets and increased complexity in order to effect this assembly.

One example of a thermal regulation device for cooling electrical energy storage members consists of a thermal regulation device comprising a tube that is configured to be in contact with the electrical energy storage members and comprises at least one circulation channel for heat transfer fluid, a collecting tank that is disposed at one end of the tube and comprises collecting chambers in fluidic communication with the at least one circulation channel of the tube, and at least two connecting sleeves that are disposed on either side of the collecting tank and are configured to communicate with the same collecting chamber, the connecting sleeves having different shapes than one another.

In the context of a multi-port tube as described above by way of example, an electrical insulation function may be necessary, and a coating then needs to be applied to each exchanger which, for its part, is thermally and electrically conductive owing to the conventional optimized material choices, generally aluminum.

The area to which this electrical insulation needs to be applied is generally defined beforehand by taking a number of factors into account:
the location of the batteries with respect to the exchanger;
the potential conditions leading to the formation of an electric arc in the event of a fault at the battery pack.

The cooling of energy storage members, for example battery cells by cooling devices having multi-channel tubes sometimes requires complex shapes and/or limited functions at the inlet and/or outlet collecting tank.

Thus, by way of example, the collecting tank may act as a reference point for the assembly of the device or of the system as a whole comprising the device and the cells; it may be used as an anchor point for clip-fastening connections, or may require high mechanical strength linked to the production, assembly or use constraints.

For all these reasons, the collecting tank of a cooling device cannot thus be designed on the basis of pressed half-shells, but have more solid forms, and, for example, be made from a single piece of aluminum by an extrusion or, in particular, die casting method.

The major drawback of these types of form or method is that the material does not allow joining and permanent leaktight securing by brazing in particular, since the collecting tank and the multi-port tube to which said collecting tank needs to be connected are both produced by the method which does not include a layer of filler metal allowing brazing.

Thus, the tube does not have a clad since it has been produced by an extrusion method.

Brazing is a known method that is very advantageous for manufacturers of cooling devices, making it possible to achieve reliable and easily reproducible leaktightness. Brazing consists of a joining operation which is achieved by melting a filler metal (also referred to as “clad” in the present description) without the base metal being melted. The melting point of the filler metal therefore needs to be at a lower temperature than that of the base metal to which it is attached.

It is therefore necessary to create a leaktight connection by brazing between 2 components (collecting tank and tube) which do not comprise a clad.

It is known from the prior art to add a clad between these two components, for example by adding a ring of clad wire which will melt during a furnace brazing process or by an induction process. The ring of clad is in fact a wire plated with 4047 material; it can have a circular or oval cross section and can be easily shaped since it is malleable so as to be able to follow the profile of the parts involved that are to be brazed. One of the drawbacks of this method, besides the addition of a step and of an additional material, is that the melting of this ring tends to bring about a change in surface state on the components involved, and sometimes crystals of flux.

This change in surface state prevents the area (essentially required on the tube at least) from being covered properly with a layer of electrical insulation that is required in this type of application, the electrical insulation serving to protect all the areas situated at least at a certain distance from the batteries.

It is therefore necessary to resort to a prior surface cleaning action, using a laser, for example, in order for it to be possible to carry out this operation, this bringing about an additional cost.

There is therefore a need for a device which makes it possible to overcome at least some of the drawbacks of the prior art.

The present invention thus proposes a thermal regulation device for cooling electrical energy storage members, the thermal regulation device comprising a tube that is configured to be in contact with the electrical energy storage members and comprises at least one circulation channel for heat transfer fluid, in particular a plurality of circulation channels, and a collecting tank that is disposed at one end of the tube and comprises at least one collecting chamber in fluidic communication with the at least one circulation channel of the tube, which is connected to a first end of the tube, the collecting tank comprising a first part and a second part secured to the first part and to the tube, characterized in that the second part of the collecting tank comprises:
an orifice defined by a raised edge configured to be passed through by the tube,
a peripheral edge that is intended to be in contact with the first part of the collecting tank, and allows it to be secured thereto, preferably by brazing.

Advantageously, such a device allows leaktight joining without addition of a ring of clad, by virtue of the second part of the collecting tank, which acts as a securing interface between the collecting tank and the tube, while the first part is now no longer dependent on this function and can therefore dispense with this need in order to meet constraints or other needs, for example mechanical strength, or the function of an anchoring point or reference point for the assembly.

According to one feature of the invention, the second part of the collecting tank is pressed.

According to one feature of the invention, the first part forms at least one, preferably two collecting chambers, the second part of the collecting tank forming a cover for the collecting chamber or chambers and being configured to form the fluidic interface between the collecting chamber and the tube, when it is secured to the first part of the collecting tank.

According to one feature of the invention, the first part comprises at least one cylinder, preferably two cylinders, forming the at least one, in particular two, collecting chambers, the second part of the collecting tank closing one side of the cylinder or cylinders. Thus, the second part of the collecting tank has an additional function of a cover closing the cylinder or cylinders of the first part of the collecting tank, the other side of the cylinder or cylinders being able, for example, to be connected to a heat transfer fluid inlet and/or outlet.

Advantageously, the cylindrical shape makes it easier to manufacture the first part of the collecting tank by extrusion, and thus to limit the manufacturing costs.

According to one feature of the invention, the second part of the collecting tank is secured to the tube at the raised edge, in particular by brazing.

According to one feature of the invention, the second part of the collecting tank is secured to the first part at the peripheral edge, in particular by brazing.

According to one feature of the invention, the first part of the collecting tank is formed by extrusion or die casting, preferably by extrusion.

Advantageously, this makes it possible to obtain a part that meets significant constraints without there being a need to worry about having a layer of clad allowing securing by brazing.

According to one particular feature, the first part of the collecting tank is formed by extrusion.

According to one particular feature, the first part and the second part of the collecting tank, and the tube are made of metal.

According to one feature of the invention, the second part of the collecting tank has two faces and comprises a coating of filler metal on one face, in contact with the first part of the collecting tank and the tube, configured to allow the second part to be secured to the first part and the tube by brazing.

Advantageously, in this alternative, an inner clad material is sufficient to ensure the connection between the tube, the first and the second part of the collecting tank. The first part of the extruded collecting tank could be inserted during assembly in abutment against the bottom of the second part of the collecting tank, the tube for its part also being guided into abutment against this extruded tank.

According to one feature of the invention, the second part of the collecting tank may also have a form provided at its center allowing brazing to the multi-port tube, thereby creating the circulation in a U shape without leaks.

According to one feature of the invention, the raised edge of the orifice in the second part extends in the opposite direction to the direction in which the peripheral edge extends.

According to one feature of the invention, the second part of the collecting tank has two faces and comprises a coating of filler metal on said two faces, configured to allow the second part to be secured to the first part and the tube by brazing.

In some cases, a material clad on two faces is necessary to ensure the connection of the tube to the second part of the collecting tank, by virtue of the addition of material to be brazed to the outer face, and the second part of the collecting tank to the first part of the extruded collecting tank, by virtue of the addition of material to be brazed to the inner face.

In certain embodiments, the raised edge has, at its center, a bridge of material separating the orifice into two, next to which the tube will be inserted in abutment. The first part of the collecting tank may also have a nose forming a stop, said first part of the tank then, for its part too, being joined in abutment against this bridge of material at the nose forming a stop.

According to one feature of the invention, the raised edge of the orifice in the second part extends in the same direction as the peripheral edge.

According to one feature of the invention, the peripheral edge may itself comprise a flat edge at its free end.

According to one feature of the invention, the first part of the collecting tank has a nose forming a stop, and at least one groove configured to be complementary to the end of the tube, such that the nose forming a stop forms the assembly stop with said tube fitted through the orifice in the second part of the collecting tank.

According to one feature of the invention, the tube comprises a plurality of circulation channels, and said groove in the first part of the collecting tank which is complementary to the end of the tube has a solid central portion in order to separate the plurality of channels of the tube into two groups when said tube is in abutting contact with said solid central portion of the first part of the collecting tank.

According to one feature of the invention, the tube comprises a plurality of circulation channels, and the second part of the collecting tank has a bridge of material separating its orifice into two in order to separate the plurality of channels of the tube into two groups when the latter is fitted in the orifice in the second part of the collecting tank, the bridge of material being configured to form an assembly stop for the tube with the collecting tank.

The invention also relates to a method for assembling a device as described above, which comprises the following steps:
providing the first and the second part of the collecting tank,
joining the first part of the collecting tank to the second part of the collecting tank such that the peripheral edge of the second part is in contact with the first part of the collecting tank,
   the first part of the collecting tank preferably forming an assembly stop so as to lock the second part of the collecting tank in a position joined to the first part of the collecting tank,
providing a tube having, in particular, a plurality of channels, the shape of which is complementary to the orifice in the second part of the collecting tank, and inserting the tube into said orifice until one end of the tube comes into abutment against the first part of the collecting tank or against the second part of the collecting tank,
brazing the assembly so as to secure the first part of the collecting tank, the second part of the collecting tank, and the tube irreversibly together.

The invention also relates to an assembly kit for forming a cooling device as described above, comprising a first part of the collecting tank, a second part of the collecting tank, and a tube having at least one circulation channel for heat transfer fluid, in particular a plurality of channels,

characterized in that the second part of the collecting tank comprises:
an orifice defined by a raised edge configured to be passed through by the tube,
a peripheral edge that is intended to be in contact with the first part of the collecting tank, and allows it to be secured thereto, preferably by brazing.

According to one feature of the invention, the device may allow the fluid to circulate in a U or an I shape.

According to one feature of the invention, the connecting tank is therefore equipped with at least two connecting sleeves.

According to one feature of the invention, the collecting tank comprises a connecting sleeve of a first type and a connecting sleeve of a second type. The difference in shape of the connecting sleeves makes it possible, when two identical thermal regulation devices are joined together to form part of an electrical energy storage device having several rows of electrical energy storage members in particular, to engage a connecting sleeve of a first type associated with a first thermal regulation device directly with a sleeve of a second type associated with a second thermal regulation device.

Advantageously, this avoids the need to provide an assembly having connecting sleeves with identical shapes that need to be connected by an additional sheath, and thus avoids multiplication of the manufacturing tolerances and misalignments.

According to another feature of the invention, the two connecting sleeves are identical.

According to one feature of the invention, the second part of the collecting tank and the two connecting sleeves form a one-piece assembly. In particular, the collecting tank and the connecting sleeves can be made of the same material, and more particularly made of aluminum. Additionally, the collecting tank, the connecting sleeves and the tube form a one-piece assembly.

In order to ensure the connection of a battery cooler A to an adjacent battery cooler B within the pack and thus to create a circulation of fluid, the connecting elements comprise specific elements of corresponding shape, such as a male part on the battery cooler A and a female part on the battery cooler B, said connecting elements preferably being made of aluminum which will be brazed directly to the tanks of the coolers, themselves made of aluminum, a sealing member such as an O-ring being added at the connection of two cooling devices, such as a lip seal or an X-ring, for example, which could be positioned either on the male part or inside the female part.

According to one feature of the invention, the one-piece assembly formed by at least the collecting tank and the connecting sleeves is obtained by a brazing operation.

According to one feature of the invention, the collecting tank includes the connecting elements or the latter are attached independent components. These elements may be extruded or pressed, and welded to the collecting tank by brazing, respectively with or without a ring.

According to one feature of the invention, one of the two connecting sleeves, so as to form a male element, has an outside diameter, at a free end opposite the collecting tank, which is slightly smaller than the inside diameter of the other of the two connecting sleeves at a free end opposite the collecting tank, this other connecting sleeve being intended to form a female element.

According to one feature of the invention, one of the two connecting sleeves has a free end, facing away from the collecting tank, which has external dimensions smaller than the corresponding external dimensions of this connecting sleeve in the vicinity of the collecting tank, and/or the other of the two connecting sleeves has a free end, facing away from the collecting tank, which has internal dimensions greater than the corresponding internal dimensions of this connecting sleeve in the vicinity of the collecting tank.

In other words, the thermal regulation device has a connecting sleeve of a first type which has a male form, where applicable, which tends to narrow with increasing distance from the collecting tank, and a connecting sleeve of a second type which has a female form, where applicable, which tends to widen with increasing distance from the collecting tank in an opposite direction to the direction in which the connecting sleeve of the first type extends, the male form and the female form of these connecting sleeves allowing direct cooperation, in particular by press fitting, between two connecting sleeves of two adjacent thermal regulation devices.

According to one feature of the invention, the tube has two separate sets of circulation channels and the collecting tank has two collecting chambers in fluidic communication respectively with one of the sets of circulation channels of the tube.

According to one feature of the invention, the device also comprises two pairs of connecting sleeves that are disposed, with a connecting sleeve on either side of the collecting tank, so as to communicate with each of the collecting chambers, the pairs of connecting sleeves being configured such that a connecting sleeve of a first pair of connecting sleeves that is disposed on a first side of the collecting tank has a shape and dimensions that are identical to those of a connecting sleeve of the second pair of connecting sleeves that is disposed on the second side of the collecting tank.

The invention also relates to an electrical energy storage device for an electric or hybrid vehicle, comprising several sets of electrical energy storage members and several thermal regulation devices as mentioned above, each thermal regulation device being arranged between two sets of electrical energy storage members, two adjacent thermal regulation devices being configured to be connected in a leaktight manner by direct cooperation of a connecting sleeve of a first thermal regulation device, equipped with a seal, with a connecting sleeve of a second thermal regulation device.

### DETAILED DESCRIPTION OF THE FIGURES

Other features, details and advantages of the invention will become more clearly apparent from reading the following description and from several exemplary embodiments given by way of nonlimiting indication with reference to the appended schematic drawings, in which:

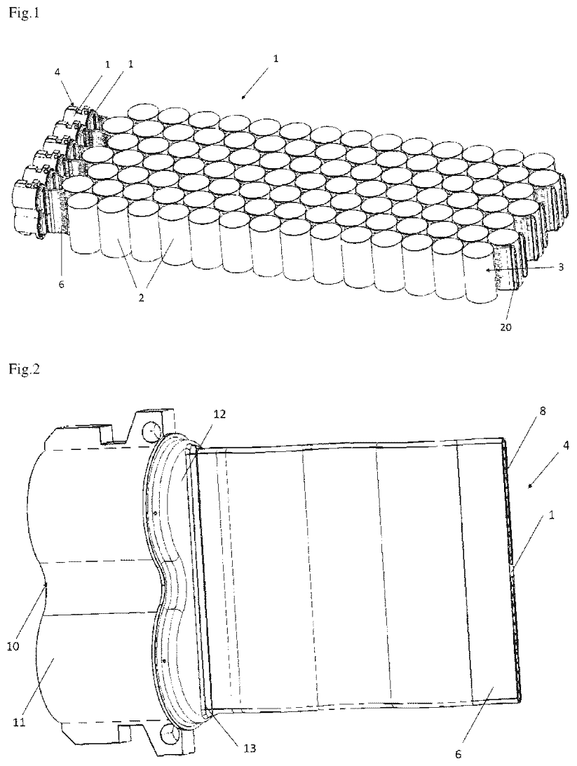

FIG. 1 is a perspective depiction of a battery pack in its entirety that is equipped with several electrical energy storage members and with a plurality of thermal regulation devices according to one example;

FIG. 2 is a schematic view of a detail of a thermal regulation device according to a first embodiment;

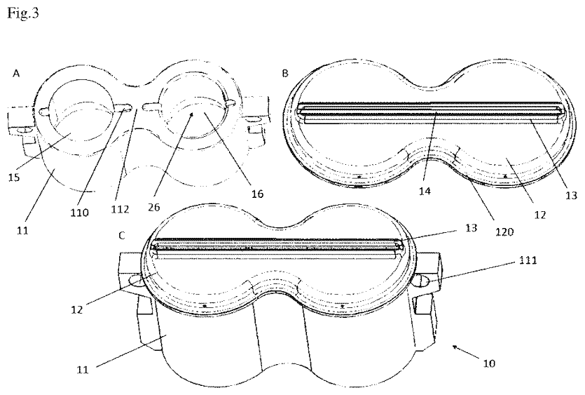

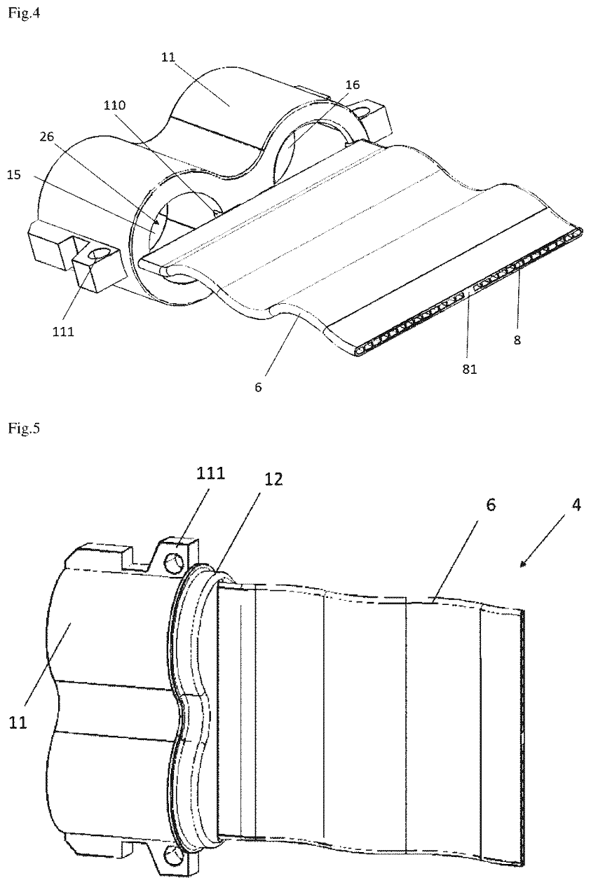

FIG. 3 is a schematic view of the first part (3A) and of the second part (3B) of the collecting tank of the thermal regulation device and the assembly (3C) thereof according to a first embodiment;

FIG. 4 is a schematic perspective depiction of a thermal regulation device according to a first embodiment, wherein the second part of the collecting tank is not visible so as to reveal the connection;

FIG. 5 is a schematic view of a detail of a thermal regulation device according to a second embodiment;

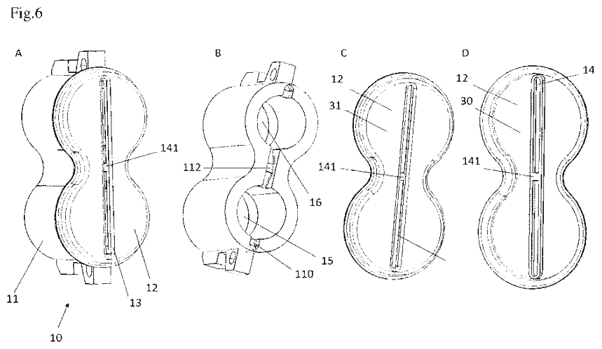

FIG. 6 is a schematic view of the first part (3B) and of the second part (3C, external view, and 3D, internal view) of the collecting tank of the thermal regulation device and the assembly (3A) thereof according to a second embodiment;

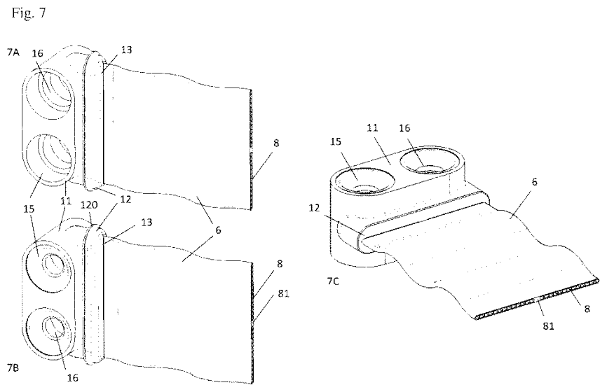

FIG. 7 is a schematic view of a detail of a thermal regulation device according to a third embodiment.

The features, variants and different embodiments of the invention can be combined with one another, in various combinations, as long as they are not mutually incompatible or mutually exclusive. It will be possible, in particular, to conceive of variants of the invention that comprise only a selection of the features described below, in isolation from the other features described, if this selection of features is sufficient to confer a technical advantage and/or to distinguish the invention from the prior art.

In the following description, the terms “longitudinal”, “transverse” and “vertical” refer to the orientation of a thermal regulation device according to the invention. A longitudinal direction corresponds to a main direction of extension of a thermal regulation device and a transverse direction corresponds to a direction that is substantially perpendicular to a main plane of extension of a thermal regulation device and to a main direction of extension of a hydraulic connecting sleeve of the thermal regulation device, this transverse direction being perpendicular to the longitudinal axis L. Lastly, a vertical direction is perpendicular to the longitudinal direction and to the transverse direction.

The term “clad” is understood to mean, in the explanations, the filler metal having a melting temperature lower than the temperature of the metal bearing it.

The present invention thus relates to a thermal regulation device (4) for cooling electrical energy storage members (2), the thermal regulation device (4) comprising a tube (6) that is configured to be in contact with the electrical energy storage members and comprises at least one circulation channel (8) for heat transfer fluid, in particular a plurality of circulation channels (8), and a collecting tank (10) that is disposed at one end of the tube (6) and comprises at least one collecting chamber (26) in fluidic communication with the at least one circulation channel (8) of the tube (6), which is connected to a first end of the tube (6), the collecting tank comprising a first part and a second part secured to the first part and to the tube (6), characterized in that the second part of the collecting tank comprises:
an orifice 14 defined by a raised edge 13 configured to be passed through by the tube 6,
a peripheral edge 120 that is intended to be in contact with the first part 11 of the collecting tank 10, and allows it to be secured thereto, preferably by brazing.

The present invention also comprises the following features, taken on their own or in combination:

Application of a coating to the multi-part tube part 6 which has a uniform and continuous geometry.

According to one feature of the invention, the device 4 may allow the fluid to circulate in a U or an I shape.

By way of example, an electrical energy storage device 1, intended in particular to equip an electric or hybrid vehicle, comprises several sets of electrical energy storage members 2, also referred to as electrical energy storage cells 2 in the following text, and several thermal regulation devices 4 arranged in the vicinity of these cells in order to allow heat exchange therebetween.

The electrical energy storage members 2 are, in particular, in the form of cylindrical cells, in this case with a circular cross section, that are disposed vertically, that is to say perpendicularly to the longitudinal and transverse plane in which the electrical energy storage device 1 is mainly inscribed.

The electrical energy storage members 2 are, in particular, disposed in successive, mutually parallel rows 3, and each row, or set of electrical energy storage members, extends mainly longitudinally.

Thermal regulation devices 4 are disposed between two adjacent rows 3 of electrical energy storage members 2, in particular with a tube 6 which is configured to be in contact with the electrical energy storage members 2 of these two adjacent rows 3.

In the illustrated example, the rows 3 are disposed in staggered fashion with respect one another, that is to say with a longitudinal offset of the storage members of one row with respect to the storage members of the adjacent row, thus making it possible to optimize the size of the electrical energy storage device 1, and the thermal regulation devices 4 each comprise a tube 6 of corrugated shape so as to be able to be in contact with each of the electrical energy storage members 2 of the two rows 3 between which they respectively extend.

Heat transfer fluid is intended to circulate inside this tube 6 of corrugated shape so as to be able to exchange heat energy with the electrical energy storage members 2, via the heat-conducting wall of the tube. In particular, when the electrical energy storage members 2 need to be cooled following a rise in temperature during their operation, the heat transfer fluid is intended to pick up the heat energy and discharge it from the electrical energy storage device 1.

In order to allow this exchange of heat energy, each thermal regulation device 4 comprises the abovementioned tube 6, in this case of corrugated shape, within which at least one circulation channel 8 for heat transfer fluid is formed, and at least one collecting tank 10 which is disposed at one longitudinal end of the tube 6 and which is intended to collect the fluid from a heat transfer fluid intake duct 15 and to distribute it into the circulation channel or channels 8 within the tube 6 and/or which is intended to collect the heat transfer fluid at the outlet of the tube 6 and to direct it into a heat transfer fluid discharge duct 16.

In other words, the heat transfer fluid is intended to circulate in the intake duct 15, and at least a portion of heat transfer fluid is directed toward this collecting tank of the associated thermal regulation device.

An electrically conductive material is understood to be any material exhibiting electrical conductivity that may generate electric arcs in the field of use of the cooling device. By way of nonlimiting example, when the cooling device is used for cooling automotive battery cells, the sleeves, collecting tank and tube are made of a conductive material such as metal, in particular aluminum.

In one example of the thermal regulation device, as shown in FIG. 1, the circulation of the fluid is referred to as U-type circulation, that is to say with the same portion of heat transfer fluid circulating in both directions within the tube 6 after having passed through a return tank 20 at one of the longitudinal ends of the tube.

More particularly, in this embodiment, the thermal regulation device 4 comprises a tube 6 and, at each of its longitudinal ends, a collecting tank 10 and a return tank 20.

The tube 6 comprises several channels 8 formed within it, which are divided into two circulation assemblies that are distinguished in that the same portion of heat transfer fluid circulates in the first circulation direction within the channels 8 of a first circulation assembly and in a second circulation direction, opposite to the first circulation direction, within the channels of a second circulation assembly.

The return tank 20 disposed at a second longitudinal end of the tube 6 does not comprise a collecting tank or connecting sleeves and is only fluidically connected to the tube 6. The return tank 20 is configured to guide the fluid circulating in one direction in one portion of the circulation channels to the other portion of the circulation channels such that it circulates in the other direction.

In a second example of a thermal regulation device 4, which is not shown, the circulation of the heat transfer fluid is referred to as I-type circulation, that is to say with the same portion of heat transfer fluid circulating in only one direction within the tube 6.

More particularly, in this second embodiment, the thermal regulation device 4 comprises a tube 6 and, at each of its longitudinal ends, a collecting tank 10.

Again, the tube 6 comprises several channels 8 formed within it, which are divided into two circulation assemblies that are distinguished this time in that two different portions of fluid can circulate separately within the tube 6, in their respective set of channels 8. A first portion of heat transfer fluid can thus circulate in the first circulation direction within the channels of the first circulation assembly and a second portion of heat transfer fluid can circulate in a second circulation direction, opposite to the first circulation direction, within the channels of the second circulation assembly. This configuration results in two separate circuits.

In an alternative that is not shown here, an I-type circulation of the heat transfer fluid may be implemented with heat transfer fluid that circulates only in one direction within the tube 6, and with collecting tanks at each end of the tube. The heat transfer fluid circulates in the same direction in each of the channels within the tube, between a collecting tank forming a supply collecting tank at one end of the tube 6 and another collecting tank forming a discharge collecting tank at the other end of the tube.

FIG. 2 shows a first embodiment, by way of nonlimiting example, of a thermal regulation device 4 comprising a tube 6 comprising at least one circulation channel 8 for heat transfer fluid, in this case a plurality of channels 8, which is joined to a two-part collecting tank 10, the first part 11 being secured to the second part 12 at the peripheral edge of the second part 12. The second part 12 comprises a raised edge 13 around an orifice 14 through which the tube 6 passes. The raised edge 13 in this case extends toward the tube 6 so as to have a wall in contact therewith and allowing brazing by virtue of the presence of a filler metal, also referred to as “clad”, on the internal face 30 of this raised edge 13. The same internal face 30 ends peripherally with the peripheral edge 120 in brazed contact with the first part 11 of the collecting tank 10.

In detail, as shown by way of example in FIG. 3, the first part 11 of the collecting tank 10 (FIG. 3A) in this case comprises a nose forming a stop 112 and grooves 110 that are complementary with the shape of the tube 6 such that the nose forming a stop 112 forms the assembly stop with said tube 6 during the insertion thereof passing through the orifice 14 in the second part 12, the perimeter of which is formed by the raised edge 13 (FIG. 3B). The grooves 110 are arranged so as to allow all of the channels 8 of the tube 6 to be supplied, without any risk of these channels being blocked by brazing. They also make it possible to clear these areas in order to ensure that the joining in abutment of the tube 6 to the first part 11 of the collecting tank 10 is carried out correctly on the nose forming a stop 112 and not on the rest of the face of the first part 11.

It should be noted that the gripping of the assembly of the two parts 11, 12 of the collecting tank 10 (FIG. 3C) can be ensured or improved by the optional presence of lugs 111 formed on the extruded first part 11. Said lugs 111 are helpful in particular for handling the components on the assembly lines.

As mentioned, FIG. 4 shows a thermal regulation device 4 comprising a tube 6 comprising at least one circulation channel 8 for heat transfer fluid, in this case a plurality of channels 8, from which the second part of the collecting tank, which helps to form the collecting tank 10, has been removed in order to reveal the interior of the latter and the presence of grooves 110 in the first part of the collecting tank.

The tube 6 has a plate shape extending along a longitudinal main direction of elongation, so as to follow the longitudinal direction of elongation of the row 3 of cells with which the tube 6 has to be in contact in order to perform the heat exchange function.

More particularly, the tube 6 in this case has a corrugated shape with a succession of crests along the longitudinal direction of elongation of the tube 6, so as to be able to be in contact with each of the cells of the rows 3 surrounding tube 6, these rows being arranged in staggered fashion. It will be understood that the channels 8 within the tube 6 follow the corrugated shape. A blocked, in particular central, and optional channel 81 makes it possible to separate the two assemblies for circulation of fluid circulating in the tube 6.

Another embodiment is shown by way of example in FIG. 5, in which the second part 12 of the collecting tank 10 in this case has a raised edge 13 extending in the direction of insertion of the tube 6, as can be seen in FIGS. 6A, 6C and 6D.

FIG. 6A shows the assembly of the two parts 11, 12 according to a particular embodiment in which the second part 12 of the collecting tank 10 comprises a bridge of material 141 at the orifice 14, which makes it possible to act as an insertion stop for the tube 6 while making it possible to act as a stopper for blocking and/or securing to a channel 8 of the tube 6 so as to separate the circulation channels 8 of the tube 6 into two circulation assemblies.

The first part 11 of the collecting tank 10 may optionally comprise a stop forming a nose 112 which may have the same function of making it possible to block and/or secure to a channel 8 of the tube 6 so as to separate the circulation channels 8 of the tube 6 into two circulation assemblies, or may serve as a support for the bridge of material 141 in order to stiffen the assembly and make it easier to assemble the two parts 11, 12 of the collecting tank 10.

In this embodiment, the internal wall 30 (FIG. 6D) and the external wall 31 (FIG. 6C) of the second part 12 of the collecting tank comprise an addition of material allowing the second part 12 of the collecting tank to be brazed to the tube 6 and to the first part 11 of the collecting tank.

Advantageously, the second part 12 with a raised edge 13 extending in the opposite direction to the peripheral edge 120 and to the insertion of the tube 6, also referred to as external raised edge, as shown in FIG. 3, makes it possible to require an addition of material for securing by brazing only on an internal face 30, thereby limiting the risk of adhesion to the brazing support during the method of joining by brazing.

In addition, the bottom of the second part 12 is flat, thereby facilitating manufacture and joining to the first part 11 of the tank, the tube 6 and the first part 11 of the tank being in abutment through the second part 12.

By contrast, advantageously, the second part 12 with a raised edge 13 extending in the same direction as the peripheral edge 120 and as the insertion of the tube 6, also referred to as internal raised edge, as shown in FIG. 6, makes it possible to reduce the risks of joining during the insertion of the tube 6.

Moreover, when there is a bridge of material 141, it can provide the addition of material necessary to ensure the brazed connection and not to have an internal leak.

It is, however, necessary to have an addition of material (clad) for brazing on the two, internal and external faces 30, 31 of the second part 12.

FIGS. 7A, 7B and 7C show embodiments of the invention in which the first part 11 of the collecting tank 10 is formed so as to have lateral inlets and outlets. In FIG. 7A, the second part 12 of the collecting tank 10 has a raised edge extending in the opposite direction to the insertion of the tube, that is to say in the direction of the major part of the tube. By contrast, in FIG. 7C, the second part 12 of the collecting tank 10 has a raised edge 13 extending in the direction of the insertion of the tube 6, that is to say extending toward the first part 11 of the collecting tank 10.

A method for assembling an electrical energy storage device 1 as was described earlier will now be described. FIGS. 7A and 7B show the intake duct 15 and discharge duct 16. It is quite possible to have, as shown, two male inlets on one side and two female outlets on the other, or to have a female outlet and a male inlet on each side.

A first step of providing a cooling device 4 as described above is followed by a step during which electrical energy storage members 2 are placed against a tube 6 of a first thermal regulation device 4. During this step, it is notably possible to carry out a step of placing adhesive against that face of the tube 6 which is intended to be in contact with the electrical energy storage members 2.

These steps can be carried out successively as many times as necessary depending on the requirements for cooling and energy storage.

An alternative method consists in providing cooling devices 4 in a first step, connecting them together, for example by means for distributing and collecting fluid that are connected to the collecting tanks of each cooling device, and then, in a second step, providing electrical energy storage members 2 against the tubes 6 of the thermal regulation devices 4 with or without placement of adhesive.

The invention is not, however, limited to the means and configurations described and illustrated here, but also extends to any equivalent means or configuration and to any technically operational combination of such means. By way of nonlimiting example, and as has been explained above, the shapes of the sleeves may vary as long as the connecting sleeves for connecting one thermal regulation device to another can cooperate directly with one another.

### LIST OF REFERENCE SIGNS

1. Electrical energy storage device
2. Electrical energy storage member
3. Row of cells
4. Thermal regulation device
6. Tube
8. Circulation channel for heat transfer fluid
81. Blocked channel
10. Collecting tank
11. First part of the collecting tank
110. Grooves forming a stop for the tube
111. Gripping means (lugs)
112. Nose forming a stop or solid central portion
12. Second part of the collecting tank
120. Peripheral edge
13. Raised edge
14. Orifice in the second part
141. Bridge of material
15. Intake duct
16. Discharge duct
20. Return tank
26. Collecting chambers
30. Internal face
31. External face

1. A thermal regulation device for cooling electrical energy storage members, the thermal regulation device comprising a tube that is configured to be in contact with the electrical energy storage members and comprises at least one circulation channel for heat transfer fluid, in particular a plurality of circulation channels, and a collecting tank that is disposed at one end of the tube and comprises at least one collecting chamber in fluidic communication with the at least one circulation channel of the tube, which is connected to a first end of the tube, the collecting tank comprising a first part and a second part secured to the first part and to the tube,
wherein the second part of the collecting tank comprises:
an orifice defined by a raised edge configured to be passed through by the tube,
a peripheral edge that is intended to be in contact with the first part of the collecting tank, and allows it to be secured thereto, preferably by brazing.

2. The device as claimed in claim 1, wherein the second part of the collecting tank is pressed.

3. The device as claimed in claim 1, wherein the first part forms at least one, preferably two collecting chambers, the second part of the collecting tank forming a cover for the collecting chamber or chambers and being configured to form the fluidic interface between the collecting chamber and the tube, when it is secured to the first part of the collecting tank.

4. The device as claimed in claim 1, wherein the second part of the collecting tank is secured to the tube at the raised edge, in particular by brazing.

5. The device as claimed in claim 1, wherein the second part of the collecting tank is secured to the first part at the peripheral edge, in particular by brazing.

6. The device as claimed in claim 1, wherein the first part of the collecting tank is formed by extrusion or die casting, preferably by extrusion.

7. The device as claimed in claim 1, wherein the second part of the collecting tank has two faces and comprises a coating of filler metal on one face, in contact with the first part of the collecting tank and the tube, configured to allow the second part to be secured to the first part and the tube by brazing.

8. The device as claimed in claim 1, wherein the raised edge of the orifice in the second part extends in the opposite direction to the direction in which the peripheral edge extends.

9. The device as claimed in claim 1, wherein the second part of the collecting tank has two faces and comprises a coating of filler metal on said two faces, configured to allow the second part to be secured to the first part and the tube by brazing.

10. The device as claimed in claim 1, wherein the raised edge of the orifice in the second part extends in the same direction as the peripheral edge.

11. The device as claimed in claim 1, wherein the first part of the collecting tank has a nose forming a stop, and at least one groove configured to be complementary to the end of the tube, such that the nose forming a stop forms the assembly stop with said tube fitted through the orifice in the second part of the collecting tank.

12. The device as claimed in claim 11, wherein the tube comprises a plurality of circulation channels, and wherein said groove in the first part of the collecting tank which is complementary to the end of the tube has a solid central portion in order to separate the plurality of channels of the tube into two groups when said tube is in abutting contact with said solid central portion of the first part of the collecting tank.

13. The device as claimed in claim 1, wherein the tube comprises a plurality of circulation channels, and wherein the second part of the collecting tank has a bridge of material separating its orifice into two in order to separate the plurality of channels of the tube into two groups when the latter is fitted in the orifice in the second part of the collecting tank, the bridge of material being configured to form an assembly stop for the tube with the collecting tank.

14. A method for assembling a device as claimed in claim 1, which comprises the following steps:
providing the first and the second part of the collecting tank,
joining the first part of the collecting tank to the second part of the collecting tank such that the peripheral edge of the second part is in contact with the first part of the collecting tank,
the first part of the collecting tank preferably forming an assembly stop so as to lock the second part of the collecting tank in a position joined to the first part of the collecting tank,
providing a tube having, in particular, a plurality of channels, the shape of which is complementary to the orifice in the second part of the collecting tank, and inserting the tube into said orifice until one end of the tube comes into abutment against the first part of the collecting tank or against the second part of the collecting tank,
brazing the assembly so as to secure the first part of the collecting tank, the second part of the collecting tank, and the tube irreversibly together.

15. An assembly kit for forming a cooling device as claimed in claim 1, comprising a first part of the collecting tank, a second part of the collecting tank, and a tube having at least one circulation channel for heat transfer fluid, in particular a plurality of channels,
wherein the second part of the collecting tank comprises:
an orifice defined by a raised edge configured to be passed through by the tube,
a peripheral edge that is intended to be in contact with the first part of the collecting tank, and allows it to be secured thereto, preferably by brazing.

16. The device as claimed in claim 2, wherein the first part forms at least one, preferably two collecting chambers, the second part of the collecting tank forming a cover for the collecting chamber or chambers and being configured to form the fluidic interface between the collecting chamber and the tube, when it is secured to the first part of the collecting tank.

17. The device as claimed in claim 2, wherein the second part of the collecting tank is secured to the tube at the raised edge, in particular by brazing.

18. The device as claimed in claim 2, wherein the second part of the collecting tank is secured to the first part at the peripheral edge, in particular by brazing.

19. The device as claimed in claim 2, wherein the first part of the collecting tank is formed by extrusion or die casting, preferably by extrusion.

20. The device as claimed in claim 2, wherein the second part of the collecting tank has two faces and comprises a coating of filler metal on one face, in contact with the first part of the collecting tank and the tube, configured to allow the second part to be secured to the first part and the tube by brazing.
